(19) United States
(12) Patent Application Publication
(10) Pub. No.: US 2025/0256561 A1
(43) Pub. Date: Aug. 14, 2025

(54) Modular systems for electric wheel assemblies

(71) Applicant: Ethan Christopher Beal-Brown, Bennington, VT (US)

(72) Inventor: Ethan Christopher Beal-Brown, Bennington, VT (US)

(21) Appl. No.: 18/856,403

(22) PCT Filed: Apr. 15, 2022
(86) PCT No.: PCT/US2022/024996

§ 371 Date: Oct. 11, 2024

(51) Int. Cl. B60K 7/00; B60L 50/52; B60L 50/60; B62K 11/00; H02K 11/00; H02K 11/33; H02K 21/22

(52) U.S. Cl. CPC B60K 7/0007; B60L 50/52; B60L 50/60; H02K 11/0094; H02K 11/33; H02K 21/22; B60K 2007/0092; B60L 2200/12; B62K 11/00; H02K 2213/12

(57) ABSTRACT

A modular electric wheel assembly. The assembly including a motor with a rotor in a rotary union with a stator. The motor of the brushless DC type and including a circular rotor rotating about a central axis and including a central hollow axle. The hollow axle configured for coupling with a removable energy source and/or an external energy source and including attachment structures for a plurality of attachments to enable riding by a user or configuration within a parent vehicle such as a bicycle or moped, or use as another machine type, such as a power tool or power generation machine. The rotor configured with a quick-change mechanism through a first ring configured to accept a plurality of removable wheel types and rotatable attachments, enabling a user to select a variety of unique wheel/tire types and configurations for a variety of applications.

### FEDERALLY SPONSORED RESEARCH OR DEVELOPMENT

Not Applicable.

### SEQUENCE LISTING, A TABLE, OR A COMPUTER PROGRAM

Not Applicable.

### FIELD OF THE INVENTION

The present disclosure relates to electric wheel assemblies configured for modular use with a plurality of wheel types and vehicle types. More particularly, the present disclosure relates to an electric motor assembly having a generally hollow central axle that is configured for universal use through the attachment of a plurality of accessories.

### BACKGROUND

Among electric wheel vehicles there are a variety of generally known devices which integrate brushless DC motors, batteries, motor controllers and software/firmware systems to power a single wheel. Such devices are found in a variety of form factors and types.

One such vehicle, found in U.S. Pat. No. 8,807,250 entitled “Powered Single-Wheeled Self-Balancing Vehicle For Standing User” to Chen, consists of a single, self-balancing, electrically powered wheel permanently mounted between fixed left and right foot platforms and enclosed within a fixed case that contains necessary working components and provides leg support. The vehicle is intended to be ridden facing in the direction of travel.

Another such vehicle, found in U.S. Pat. No. 9,101,817, entitled “Self-Stabilizing Skateboard” to Doerksen, consists of a single, self-balancing electrically powered wheel permanently mounted between fixed fore and aft foot platforms that contain necessary working components. The vehicle is intended to be ridden facing perpendicular to the direction of travel.

Another such vehicle, found in U.S. Pat. No. 9,636,992, entitled “Modular Systems Package for an Electrically Motorized Vehicle”, to Assaf Biderman et al., consists of a single, electrically powered wheel with a fixed bicycle axle and a bicycle wheel affixed by a plurality of spokes to the hub. The wheel is intended to be attached to the rear forks of a bicycle.

Further such vehicles, found in U.S. Pat. No. 6,302,230, entitled “Personal Mobility Vehicles and Methods”, to Dean Kamen et al., consist of integrations of motor controllers, motors, riding platforms, sensing systems, power sources, and wheels which are each self-balancing and intended to be ridden in a particular orientation relative to travel.

While these and similar vehicles utilize similar motor, power, sensing and control systems to power a single wheel, none has a structural assembly which permits the replacement of the wheel by another of a significantly different width or diameter. Further, none has a structural assembly which permits the replacement of the type of riding platform or parent vehicle structure or use the wheel was originally designed for. Consequently, if someone is interested in multiple uses for electric wheel devices, they must purchase a separate specially designed electric wheel device for each use. Lastly, none of these references provide a vehicle that exhibits these desired characteristics, and which has a robust system for mounting batteries that are capable of being removed and charged externally or easily replaced during the course of use.

Further, although an assembly which consists of an integrated controller, motor, and power source may have a wide range of utilities beyond personal transportation, these discussed devices and other such devices do not have structural assemblies which readily permit alternate uses.

Therefore, there exists a need in the market for an improved electric wheel assembly which does not suffer from these shortcomings and exhibits these desired characteristics.

### SUMMARY OF THE INVENTION

The device of the present disclosure most generally provides a universal and modular integrated hub motor, energy source, and control system assembly configured to provide a powered hub motor device capable of a plurality of uses including, but not limited to, the receipt of interchangeable wheels, tires and other rotatable couplings, preferably a selectively removable energy source within a central and generally hollow core, the attachment of riding platforms or parent vehicle structures or machine structures and the quick attachment of rotatable attachments such as wheels or gear drives to the rotor.

A modular hub motor assembly for use as a ride-on vehicle, or for use as a motor or wheel in a parent vehicle, device, or machine, is disclosed. The assembly most generally utilizes a brushless DC motor with a hollow center referred to herein as a central cavity. In one embodiment, the assembly generally utilizes a brushless DC motor of the radial flux type with a hollow center also referred to herein as a central cavity. In another embodiment, the assembly generally utilizes a brushless DC motor of the axial flux type with a hollow center. This hollow center forming the central cavity provides a space for a generally hollow axle that can be utilized for housing an interchangeable energy source, such as, but not limited to, a rechargeable/replaceable battery pack, or a plug that connects the wheel assembly to an external battery pack, or a system enabling the wheel assembly to be used as a power generator. This generally hollow center further provides robust mounting structures on a left and a right axial extent for the direct attachment of, or attachment by means of an interface device, to a plurality of riding platforms, accessories, components, and parent vehicle or machine structures. Further, at a coupling of a pair of halves of a rotor a specially designed mating coupling is provided to allow for robust mounting and quick replacement of various rotatable attachments such as tires.

Importantly, this configuration allows for the interchangeability of wheel/tire types and diameters, as there is no need for an external casing to house additional working components of the wheel assembly, which instead are located within the internal space of the axle and rotor.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough and will fully convey the full scope of the invention to those skilled in the art.

### BRIEF DESCRIPTION OF THE DRAWING(S)

FIG. 1 is an orthographic, profile and side view of the device, according to the present disclosure;

FIG. 2 is an orthographic view of the device with annotations defining a coordinate system for use in describing the device;

FIG. 3 is an orthographic, sectional view of the rotational components of the device, above;

and an orthographic, sectional view of the stationary components of the device, below, in an embodiment using a radial flux motor topology, according to the present disclosure;

FIG. 4 is an exploded view of the components of the device in one embodiment, according to the present disclosure;

FIG. 5 is an axial and a radial cross-sectional view of an embodiment of the device wherein a battery is mounted to the stator, internal to the space defined by the rotor, according to the present disclosure;

FIG. 6 is a cross-sectional view of the device, with optional foot pedal attachments, in an embodiment using a radial flux motor topology, according to the present disclosure;

FIG. 7 is an orthographic and exploded view of the at least one energy source and enclosing hollow axle of the device, in an embodiment employing a radial flux stator, according to the present disclosure;

FIG. 8 is an orthographic view of the at least one energy source and charger above; and an orthographic view of a public charging station, below, according to the present disclosure;

FIG. 9 is an exploded view of the device showing rim/tire, battery, enclosing case and pedal attachments, according to the present disclosure;

FIG. 9a is an exploded view of the device showing an interface device used to connect attachments to the axle, according to the present disclosure;

FIG. 9b is several views which illustrate two embodiments of the device wherein the device primary defining characteristics are adapted to a smaller or larger form factor, and the ratio of radius to axial length is altered accordingly, according to the present disclosure;

FIG. 10 is an orthographic, exploded, cross-sectional view of a corresponding structure by which a rim/tire assembly may be coupled with the rotor, according to the present disclosure;

FIG. 10a is an orthographic, exploded view of an alternate embodiment for a corresponding structure by which a rim/tire assembly may be coupled with the rotor, according to the present disclosure;

FIG. 10b depicts an embodiment of a corresponding structure by which a rim/tire assembly may be coupled with the rotor, and which is configured for a removable intermeshed assembly with the first ring, incorporating a polygonal shape of the first ring and fastening features, according to the present disclosure;

FIG. 10c depicts an embodiment of a corresponding structure which translates the rotation of the first ring for use, and which is configured for a removable intermeshed assembly with the first ring, incorporating a track and corresponding pins, according to the present disclosure;

FIG. 10d depicts two embodiments of a corresponding structure which translate the rotation of the first ring for use, including a corresponding structure in the form of an at least second ring, which is configured for a removable intermeshed assembly with the first ring at the first diameter, and having a second diameter at which the at least second ring may be semi-permanently mounted to a rim/tire assembly above; and below, a corresponding structure in the form of a ring of structures which are arranged around a second first diameter, and configured for a removable intermeshed assembly with the first ring at the first diameter, according to the present disclosure;

FIG. 11 is an orthographic side view of various wheel types configured for receipt on the rotor, according to the present disclosure;

FIG. 12 is an orthographic view of an attachable covering above, and an orthographic view of the device with an attachable covering in a finished assembly below, according to the present disclosure;

FIG. 13 is an orthographic view of a pair of devices in a coupling utilizing a platform in an embodiment of the present disclosure;

FIG. 14 is an orthographic profile view of the device used in place of the front wheel and rear of a bicycle, in an embodiment of the present disclosure;

FIG. 15 is an orthographic view of the device with an attached riding platform, in an embodiment of the present disclosure;

FIG. 16 is an orthographic view of the device with an attachment enabling the device to be used as a powered belt drive, above; and an orthographic view of the device with an attachment enabling the device to be used as a powered gear drive, below, in an alternate embodiment of the present disclosure;

FIG. 17 is an orthographic view of several devices utilizing a shared power and/or control source, which may additionally communicate via wireless means between themselves or with control peripherals, according to the present disclosure;

FIG. 18 is a view of the device in use as a wind power generation machine, according to the present disclosure;

FIG. 19 is an orthographic view of a pair of devices in coupling with a frame to form a scooter-like ride on vehicle in an alternate embodiment, according to the present disclosure;

FIG. 20 is an orthographic view of a chain and sprocket attached to one side of the rotor, according to the present disclosure; and

FIG. 21 is a view of rope and a drum, such as are used in a capstan winch, attached to the attachment structures, according to the present disclosure.

### DETAILED DESCRIPTION OF THE INVENTION

### List of Parts Referenced in the Figures

10 Device
100 Motor
101 Outer circular rotor/circular rotor/pair of rotors/rotor
101a Rotor ring of magnets
102 Inner circular stator/circular stator/stator
102a Stator support structure
103 Generally hollow axle
104 First ring
105 Corresponding structure
105a At least a second ring corresponding structure
105b At least a ring of structures corresponding structure
107 Bearing
108 Battery management system
109 Controller
110 Auxiliary rotor output drive mounting feature
112 Axle exterior electrical and information interface
113 Axle interior electrical and information interface
131 Attachment structure/attachment structures
132 Riding platform(s)
133 Cover member
134 Interface device
135 At least one attachment
136 Parent vehicle structure
140 First diameter
142 Locking tabs
150 Second first diameter
151 Second diameter
200 Wheel
201 Central Axis
202 Rim
203 Tire
300 Energy source
301 Replaceable battery

The following detailed description includes references to the accompanying figures, which form a part of the detailed description. The figures show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

References in the specification to embodiments indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be semi-permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

As used herein, the term “rotor” may mean multiple things depending on the context in which it is used. In one case, it may mean an electromagnetically active portion of the brushless DC motor, such as an assembly consisting of a ring of magnets mounted to an iron ring. It may also mean a rotating body that couples an electromagnetically active portion of the brushless DC motor to the axis of rotation, in which case it is sometimes differentiated by calling it or its components “rotor shell” or “rotor shells”. It may also mean all rotating bodies in the device considered together as a unit. In general, the particular usage, if not explicitly articulated, will be determinable in the context in which it is referenced.

As used herein, the terms “attachment structure” or “attachment structures” may refer to several features, depending on the context in which they are referenced. In general, this term refers to the structures or system of structures of the generally hollow axle or interface device that permit removable attachments to be removably coupled to the device stator for use. In some embodiments, these structures will be directly formed into the generally hollow axle itself, permitting direct removable attachment of attachments. In some embodiments, these structures refer to the system by which the interface device semi-permanently attaches to the axle, in addition to the structures of the interface device itself which permit removable attachment of attachments. In one case, the terms “attachment structure” or “attachment structures” may refer to the structure or structures machined or otherwise formed into the axle such as grooves, flat faces, bolt holes, or other structures, which permit removable attachment of an interface device to the axle at its axial extents. The terms “attachment structure” or “attachment structures” may also mean the external structure of an interface device or devices themselves which permit the removable attachment of attachments such as pedals or riding platforms, or parent vehicle structures to the interface device, and transitively, to the axle and stator. The terms “attachment” structure or “attachment structures” in other embodiments may also mean structures of the axle at its axial extents which permit attachments to be directly mounted to the axle itself.

As used herein, the term “corresponding structure” or “corresponding structures” generally refers to a structure or system of structures which correspond to the features of the first ring, which permit rapid attachment of rotatable attachments. In general, these structures serve to mount to the first ring in order that they translate rotation of first ring and rotor for use and provide modularity. “Corresponding structure” or “corresponding structures” may include an at least second ring insofar as it is itself providing this function. This term may also be used to distinguish a group of structures from an at least second ring in that they may not incorporate a physical ring but rather themselves be arranged in a ring around the first ring, but nonetheless provide substantially the same functionality as an at least second ring.

As used herein, the terms “semi-permanent” and “removable” are generally intended to distinguish between two different types of coupling. Semi-permanent couplings are those which are not intended to be removed during the normal use of the device, which may be assembled at a factory or during maintenance of the device; and removable couplings are those which are specifically constructed in such a way as to be quickly removed during the normal course of use, preferentially without the use of special tools, such as when a user wants to change the riding platform or parent vehicle structure or wheel type attached to the device.

As used herein, the term “attachment” generally refers to a thing which may be removably coupled to the device and replaced during the normal course of use, and which, if it contains working components such as batteries, sensors or controllers, does not contain any working components without which the device would have no alternate substantive uses and/or be incapable of functioning as designed, and wherein an alternative attachment which does not have these working components can be attached in its stead without rendering the device incapable of performing the functions it was designed for.

The device of the present disclosure most generally provides a universal and modular integration of a hub motor, energy source, and control system assembly configured to provide a powered wheel capable of a plurality of uses including, but not limited to, the receipt of interchangeable wheels, tires and other rotatable couplings, an energy source coupled to the motor controller via the generally hollow axle, and a system providing for the attachment of riding platforms or parent vehicle or machine structures.

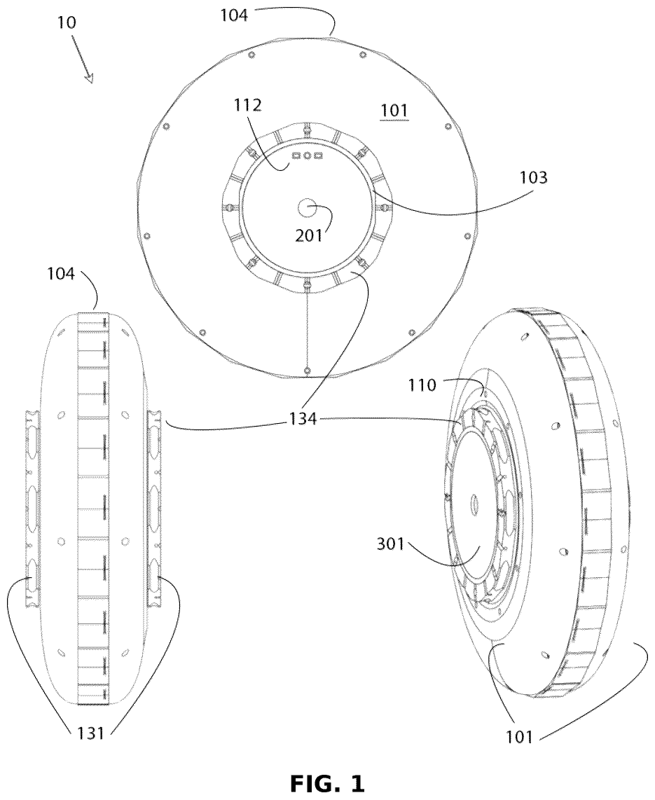

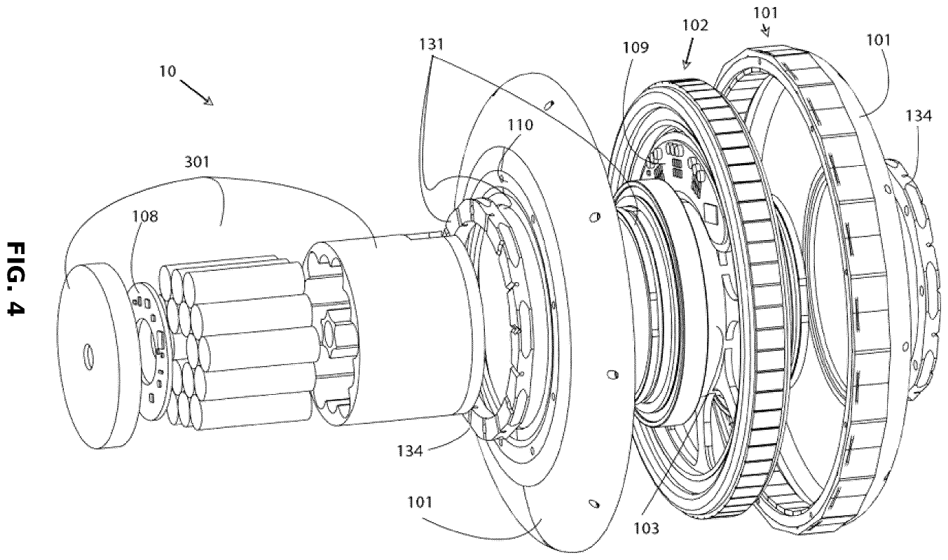

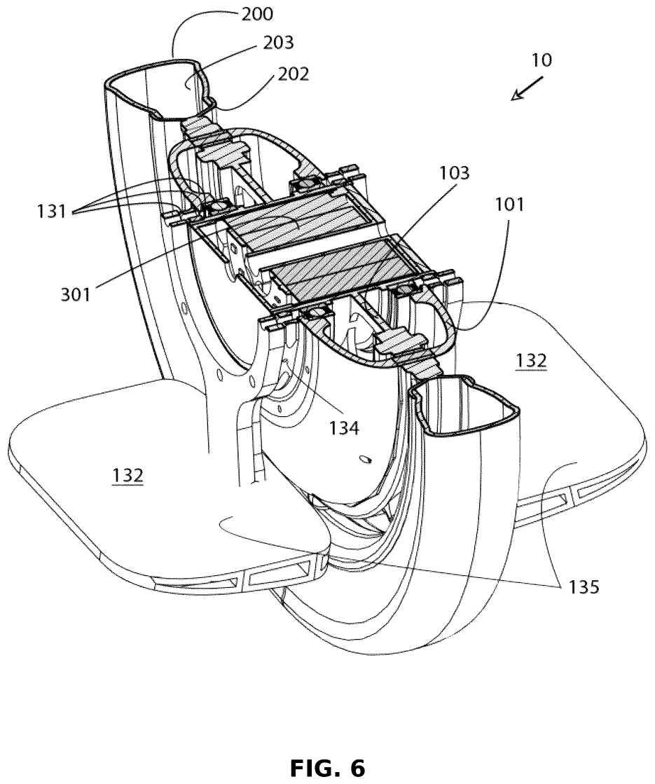

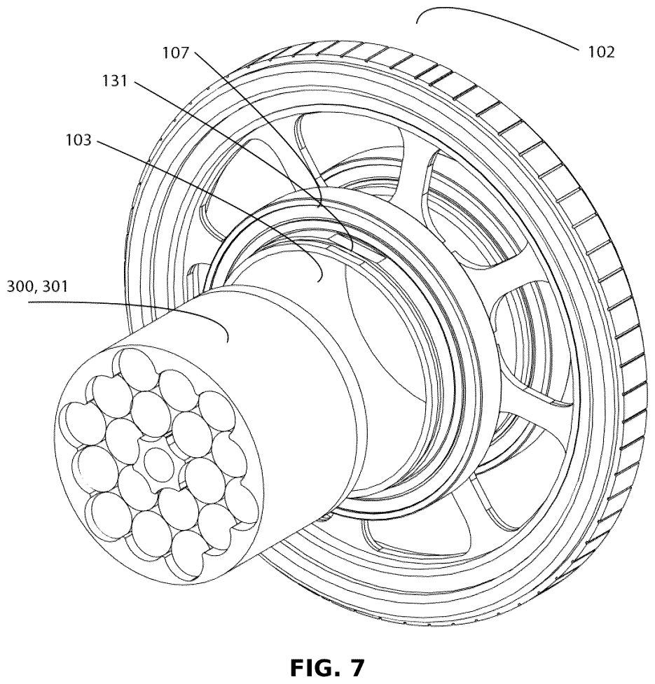

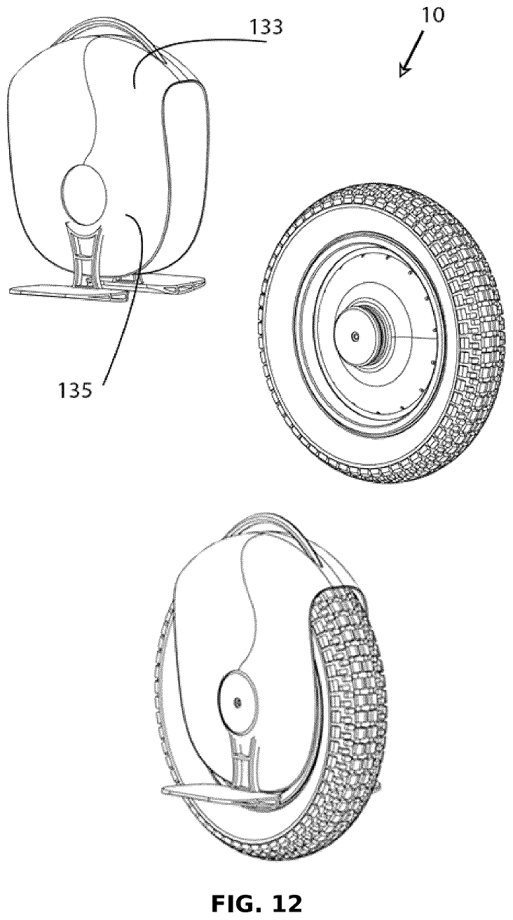

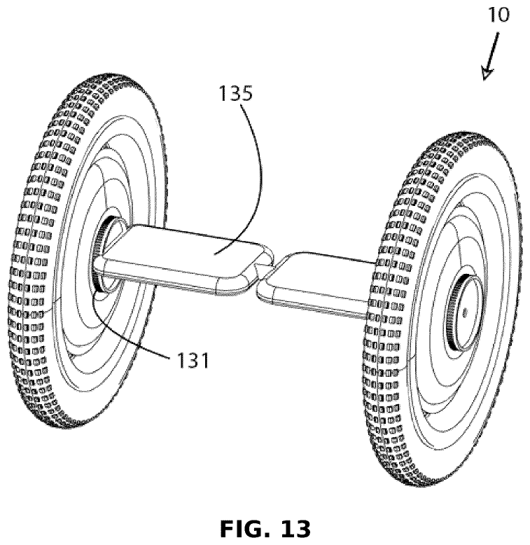

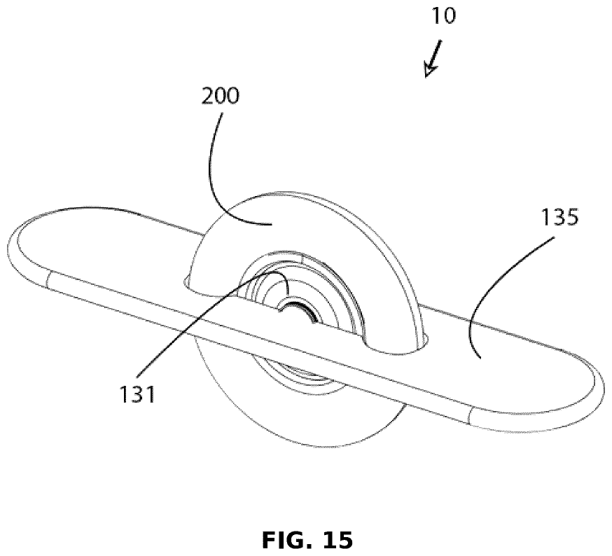

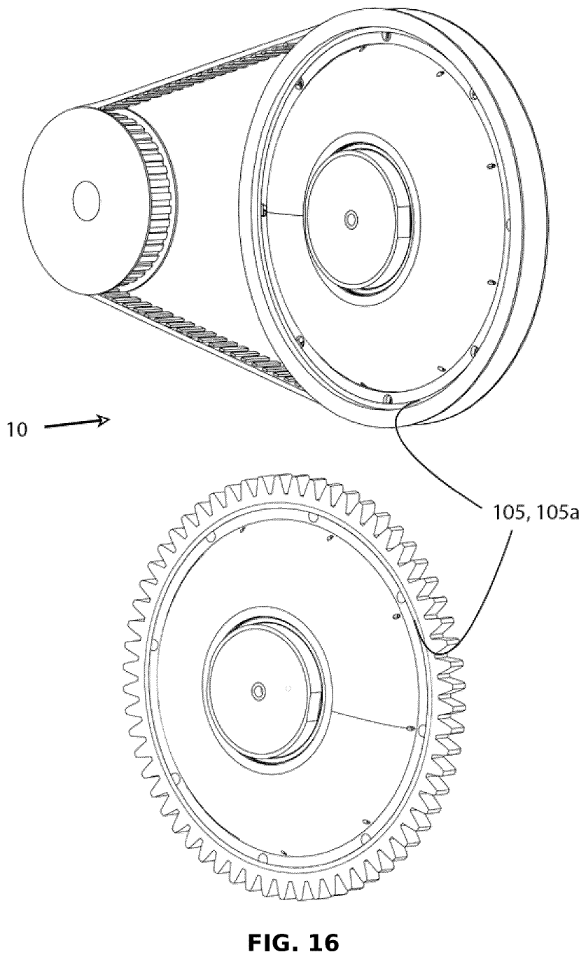

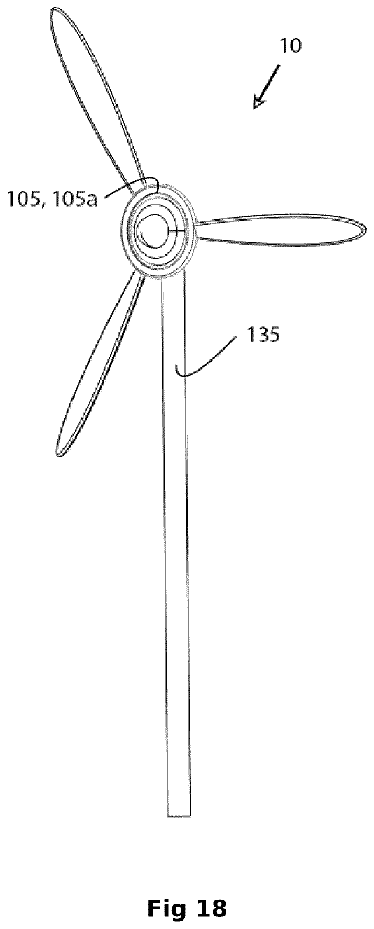

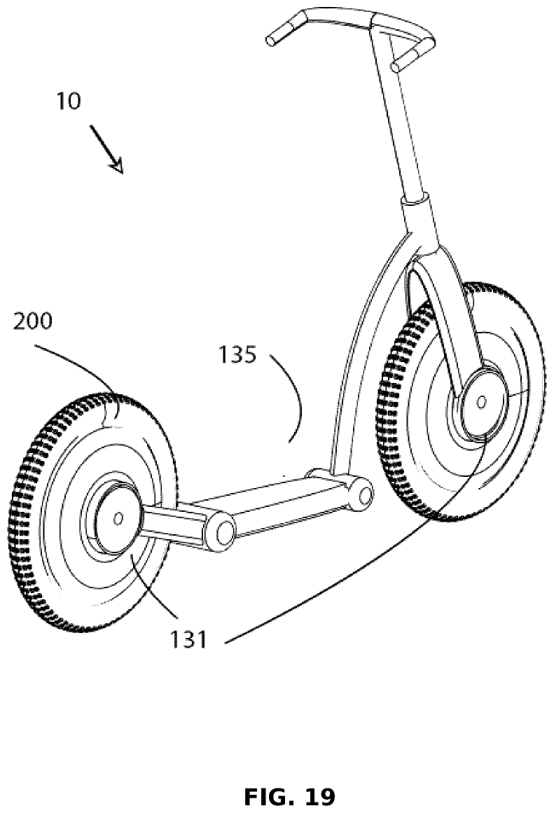

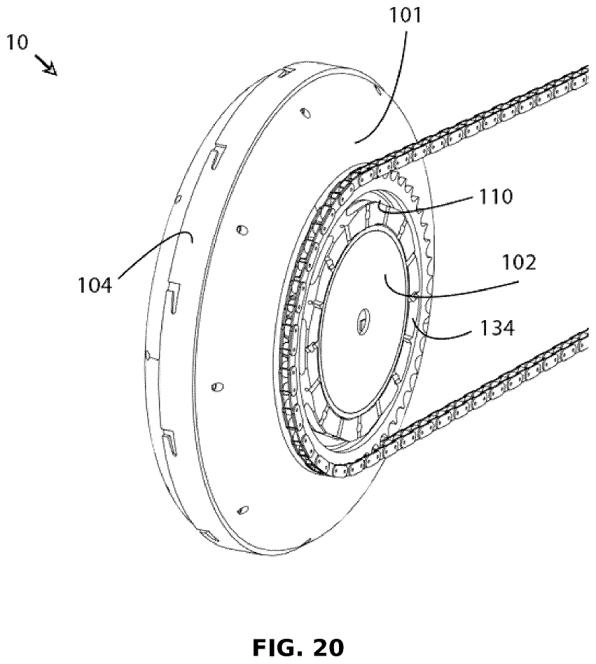

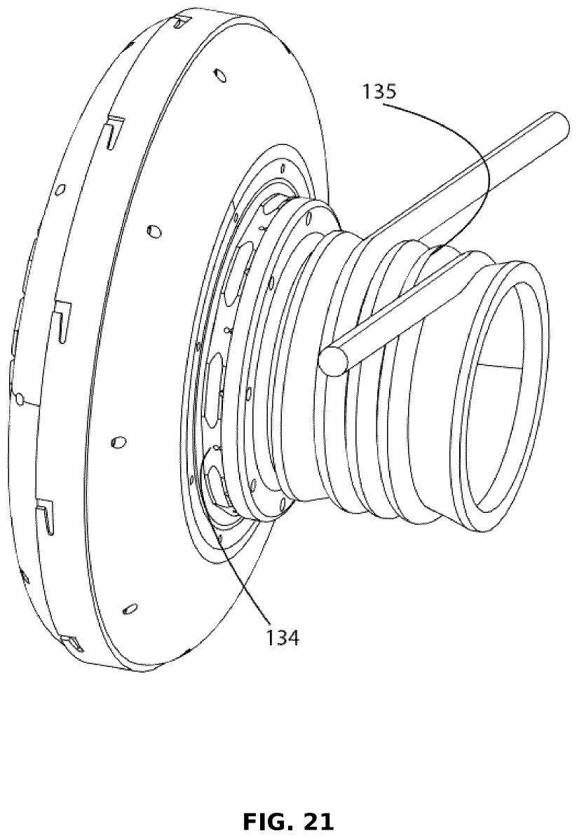

Referring specifically now to FIGS. 1-21 of the device of the present disclosure, generally in the form of a modular electric wheel assembly capable of a plurality of uses, generally referred to herein as device 10.

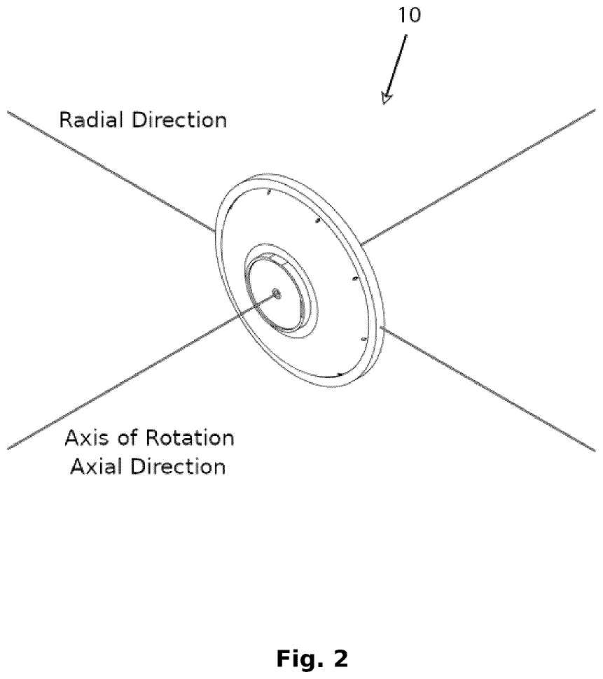

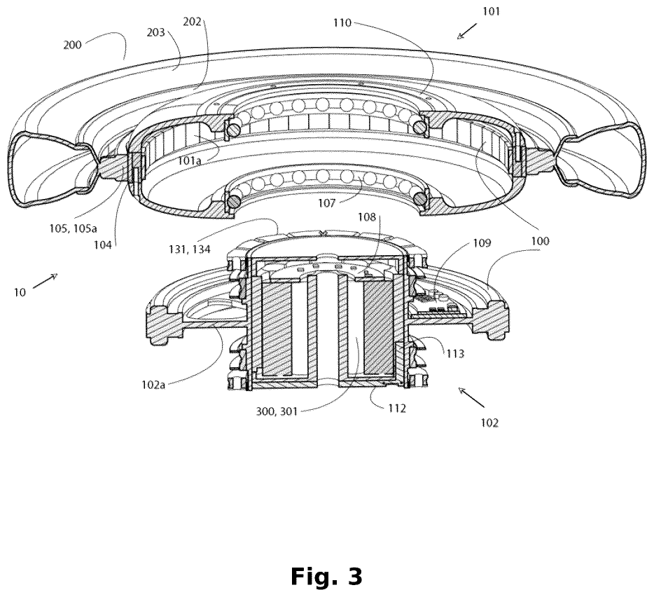

For the sake of clarity, FIG. 2 provides a coordinate system and FIG. 3 depicts all components which are rotational and/or affixed to a rotor 101 of a motor 100 in the portion of the figure and all components which are stationary and/or affixed to a stator 102 of the motor 100 in the lower portion of the figure in one embodiment of the device 10. The device 10 as depicted utilizes a motor 100 of the axial flux type. Those components which are in a fixed coupling to the rotor 101 and which rotate with the rotor 101 may themselves be referred to as the rotor 101. Those components which are in a fixed coupling to the stator 102 may be referred to as the stator 102.

The device 10 is generally depicted in preferred embodiments although other embodiments within the spirit of the inventive concept are reasonably anticipated. The device 10 is most generally configured as the motor 100 adapted to power the rotation of a wheel 200 about a central axis 201 in one or both of a clockwise and counterclockwise direction. The motor 100 is what is commonly known as a brushless DC type of motor. In one embodiment, the motor 100 is what is commonly known as an outrunner radial flux motor, wherein an outer circular rotor 101 rotates about an inner circular stator 102 in a concentric arrangement. In another embodiment, the motor 100 is what is commonly known as an axial flux type of motor, wherein a circular rotor 101 or pair of rotors 101 rotates about a circular stator 102 while positioned relative to a face or opposed faces of the stator 102. In both the radial flux and axial flux topologies, the configuration of the motor 100 provides for rotation of the rotor 101 through a magnetic coupling about a face or faces of the rotor 101 adjacent to the electromagnetically powered stator 102. These motor 100 configurations provide a central cavity defining a space for a generally hollow axle 103 positioned at a central position of the motor 100 fixed to the stator 102 and functioning for the receipt of an energy source 300 and additional electrical and mechanical components to facilitate power and control of the motor 100. Preferably, this energy source 300 is a removable and replaceable battery 301 assembly, although this energy source 300 may be mounted to an external location and/or fixed in a permanent or semi-permanent position internal to the device 10.

In another embodiment, the energy source 300 may be internal to the device 10, fixed to the stator support structure, and not be removable via the generally hollow axle 103, but still provide an external interface via a coupling with the generally hollow axle 103, such as an electrical receptacle, to facilitate charging of the battery 301, as well as receipt and transmission of electrical energy from and to sources outside the rotor 101, or outside an axial extent of the device 10.

The hollow axle 103 includes attachment structures 131 adapted for the direct receipt, or receipt by means of an interface device 134, of a plurality of accessories to enable riding of the device 10, including but not limited to, riding platforms 132, a cover member 133, a handle, a parent vehicle such as a bicycle or moped, a parent machine such as a power tool or power generator, and a plurality of additional and similar items herein now known or unknown.

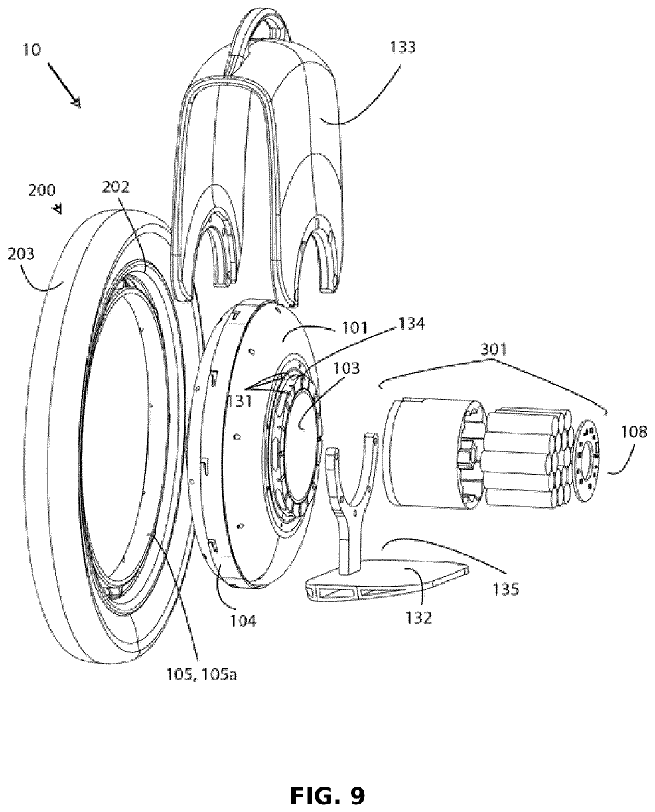

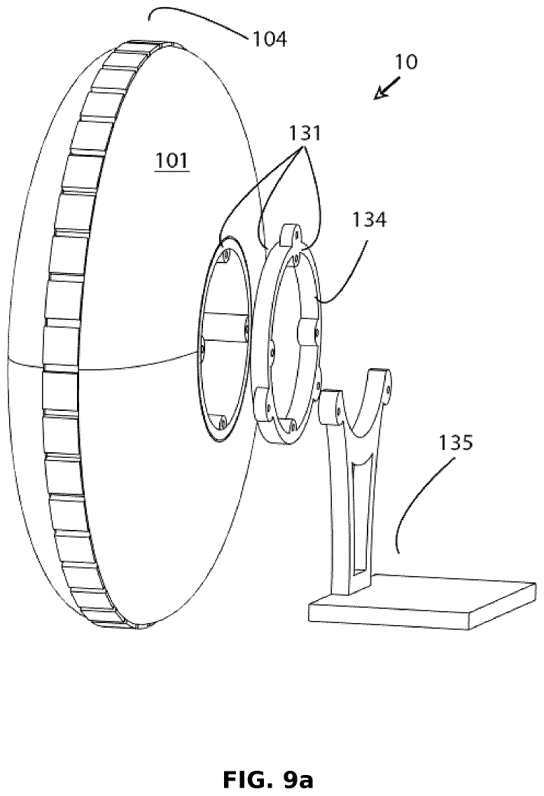

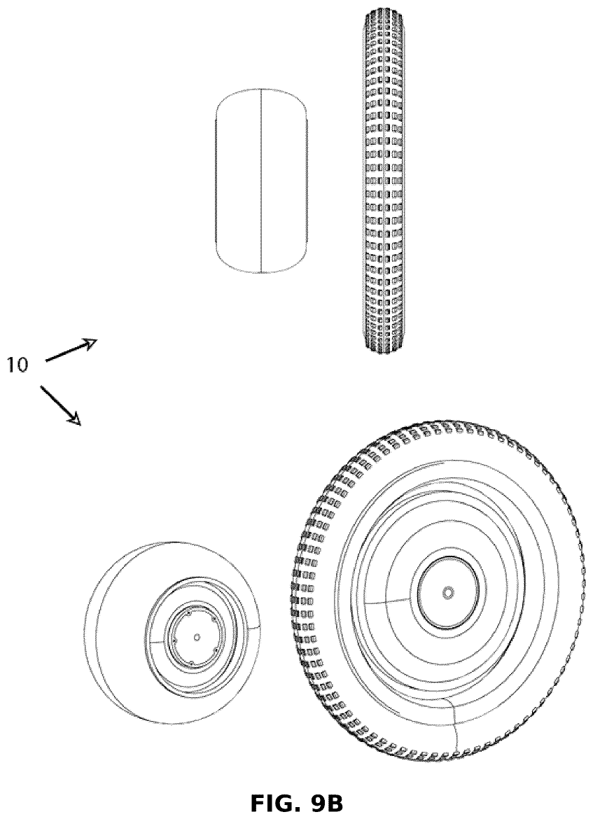

In one embodiment, as depicted in FIG. 9a., the hollow axle 103 attachment structures 131 are configured for semi-permanent receipt of the interface device 134 on either side of the device 10 which generally provide attachment structures 131 to enable the quick attachment of pedals, riding platforms 135 or other attachments which permit various different means of riding or using the device 10 or the attachment of additional brackets or structures to permit attachment to parent vehicles such as bicycles, scooters or mopeds or other machines or machine setups. This interface device 134 may clamp or screw or be affixed by set screws or a retaining ring, clamp, or collar, or otherwise be rigidly and semi-permanently attached to the generally hollow axle 103 at its attachment structure or structures by generally known mechanical fastening means, and not be intended to be removed during the normal course of use. In order to permit this coupling of the generally hollow axle 103 and interface device 134, the generally hollow axle 103 may protrude beyond the axial extent of the rotor 101 with the attachment structure 131 of the generally hollow axle 103 permitting coupling of the interface device 134, or it may be flush with the rotor 101 and have inner structures which may allow for the coupling with the interface device 134. The interface device 134 may be configured to provide multiple separate mounting points to provide flexibility and maximum utility in terms of the type and number of attachments that may be attached to it at once. Generally, it should provide a means of receiving rapidly fastened attachments that are easy to install, have a robust connection, and once fastened are secure, wherein they do not have any freedom of movement relative to the interface device 134 or stator. In a preferred embodiment, this quick attachment will be made by the user without the use of tools. This quick attachment may alternately be made with the use of a simple tool such as a metal rod to tighten a captive cam. In other embodiments, a captive thumb screw, a spring-loaded lever, ratchet, locating pin, or other mechanism is used to secure the interface device 134.

In particular, a rigid coupling between the interface device 134 and attachment structures 131, and between the interface device 134 and the generally hollow axle 103 is important in the event that the device 10 is intended to be used as a self-balancing vehicle, since looseness of the riding platform 135 or platforms relative to the stator 102 can contribute to the emergence of feedback loops that are difficult to correct for.

In an embodiment, the interface device 134 may have a groove along an outside radius that is paired with teeth or slots or holes on a face in order to allow attachments to key in and then be fastened by means of a clamp or captive cam mechanism. In another embodiment, the interface device 134 may have threaded bolt holes and grooves or slots to locate and permit the fastening of attachments by means of loose or captive bolts. In yet another embodiment, the interface device 134 may have a series of tracks or grooves milled or otherwise fabricated to allow corresponding devices to slide into place where they may be affixed and prevented from backing out by a locating pin or spring-loaded catch or rotating wedge or cam, or ratchet and pawl type mechanism or other generally known mechanism. In general, the interface device 134 semi-permanent coupling with the device 10 is intended to permit modularity, robustness and repairability, be replaceable in case it is damaged during use, and protect the generally hollow axle 103 and interior space of the device 10 from damage, which is difficult to replace without a complete disassembly of the device 10.

Further, in some embodiments, the interface device 134 may have features which permit it to be used to exert clamping pressure on an inner race of a bearing to aid in the balancing of loads on the system and prevent bearing misalignment. The interface device 134 may also be configured to provide a housing for a radial lip seal to prevent ingress of contaminants into the space where a radial ball bearing is mounted, to prevent the possibility of the bearing becoming fouled and failing prematurely. The interface device 134 may also be configured to have heat exchanging features such as, but not limited to, a heatsink which creates a thermal pathway for heat from a controller 109 to be dissipated by airflow across the interface device 134. In another embodiment, the rotor 101 shells may have features machined or otherwise formed into them that are intended to receive a radial lip seal which provides a watertight seal against the axle 101 intended to exclude moisture and other contaminants from the interior of the device 10.

In other embodiments of the device 10, the generally hollow axle 103 itself may be configured to provide the attachment structure 131 by means of which attachments may be removably attached to the generally hollow axle 103 directly, such as, but not limited to, a plurality of grooves configured for an intermeshed assembly with corresponding teeth on the accessories, a polygonal shape which permits clamping of attachments, machine elements and features which have been previously described as potentially being present on the interface device 134, and similar structures which generally permit rapid and simple fastening with a coupled receipt the generally hollow axle 103.

The device 10 hollow axle 103 and/or the rotor 101 may have a waterproof breather valve or other feature intended to provide pressure equalization between the interior and exterior of the device 10 which excludes moisture and contaminants but reduces or eliminates pressure differentials which may be created by heating, cooling, and motion experienced during use of the device 10, to reduce the likelihood that other sealing features such as bearings or lip seals are permeated by moisture or contaminants.

As generally discussed above, the motor 100 assembly may include a variety of structures such as, but not limited to, bearings, seals, rings, sleeves, bushings, and similar components to enable relative movement and power transmission between the stator 102 and the rotor 101 and provide protection for the internal and working components of the device 10.

The motor 100 assembly having a first ring 104 with a first diameter 140 and in a semi-permanent fixed union with the rotor 101, providing a structure intended for the receipt of an at least second ring 105 and coupling of the wheel 200, wheels, or other rotatable couplings connected to the rotor 101. Preferably, the first ring 104 and wheel 200 coupling is accomplished through the use of a mating coupling comprised of an interlocking of the first ring 104 to the at least second ring 105. The at least second ring 105 having a second first diameter 150, the second first diameter 150 being substantially similar to the first diameter 140 of the first ring 104, wherein the first ring 104 and the at least second ring 105 are configured for coupling in adjacency to translate rotation of the rotor 101 to the first ring 104 and the at least second ring 105.

The first ring 104 may be placed at the radial extent of the rotor 101 shells and be configured for an intermeshed assembly with the at least second ring 105 at the first diameter 140 and the second first diameter 150 with the second ring 105 having a second diameter 151 being an outer diameter of the at least second ring 105 configured for attachment to a rim 202 of the wheel 200, or having outer features intended to mate with the rim 202 of the wheel 200 or other rotatable attachments, as is shown in FIG. 9.

Additionally, the first ring 104 may be placed at the radial extent of the rotor 101 shells and be configured for an intermeshed assembly with a corresponding structure or structures. In one embodiment, this corresponding structure may be comprised of a series of arcuate bodies or clamps, spokes, rods, or other similar features which are arranged in a ring around the first diameter 140 and serve as a removable interface between the first ring 104 and a rotatable attachment such as the rim 202 or tire and wheel 200 assembly, translating the rotation of the rotor 101 and the first ring 104 for use, and being generally removable as a single unitary body.

The first ring 104 may generally provide a set of features which permit the robust and rapid attachment of the at least second ring 105 or a corresponding structure or structures intended to interface between the first ring 104 and the rim 202 and a tire 203 or other rotatable attachment. In a preferred embodiment, this quick attachment system, made possible by the features of the first ring 104 and the at least second ring 105 or a corresponding structure or structures, does not require the use of any tools to affix securely. In other embodiments, the fastening of the first ring 104 to the at least second ring 105 or a corresponding structure or structures may be made by a captive bolt or ratchet and pawl or cam which is intended to be operated by a corresponding tool and allows the first ring 104 and the at least a second ring 105 to be rigidly coupled to one another at the first diameter 140 and the second first diameter 150.

In one embodiment, the first ring 104 when viewed in profile from the axial direction has a regular polygonal shape, and has a wedge like shape which has a larger diameter on one axial side of the device 10 than the other, rather than each side of the polygon being parallel to the axis on its radially outermost faces, which permits the at least second ring 105 or a corresponding structure or structures to be easily placed into position, and pressed into fitment until there is no remaining freedom of motion, at which point they may be fixed in place by one or many spring loaded clamps, pawls, pins, captive rotating wedges, captive rotating screws, ratchet and pawl mechanisms, or other affixing devices that may be housed in the first ring 104. In other embodiments, these and other affixing devices may be housed in the at least second ring 105 or the corresponding structure or structures.

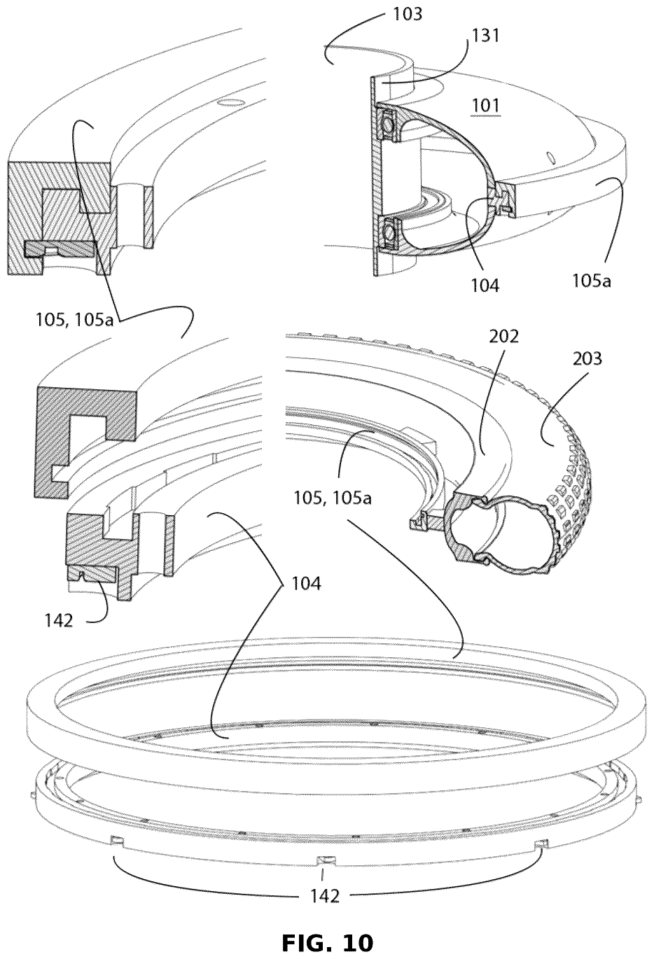

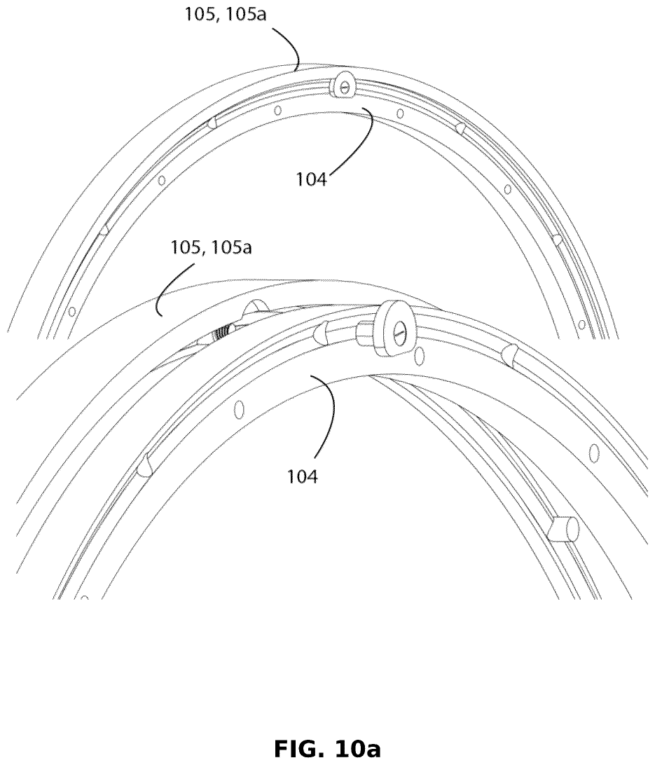

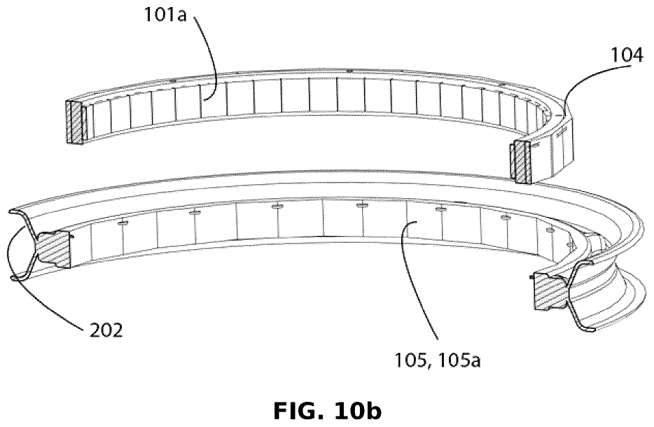

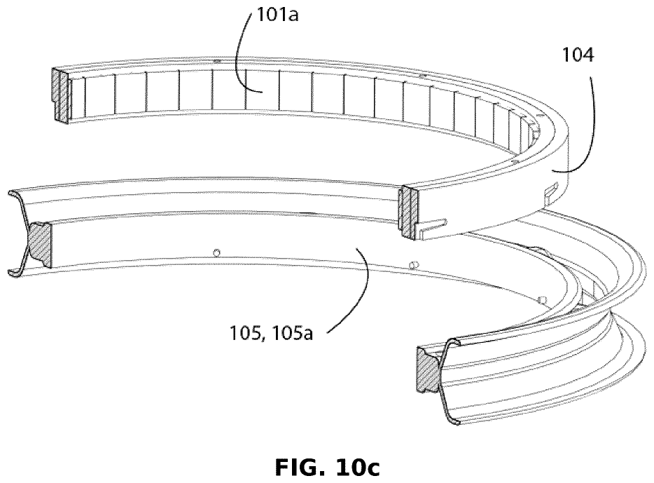

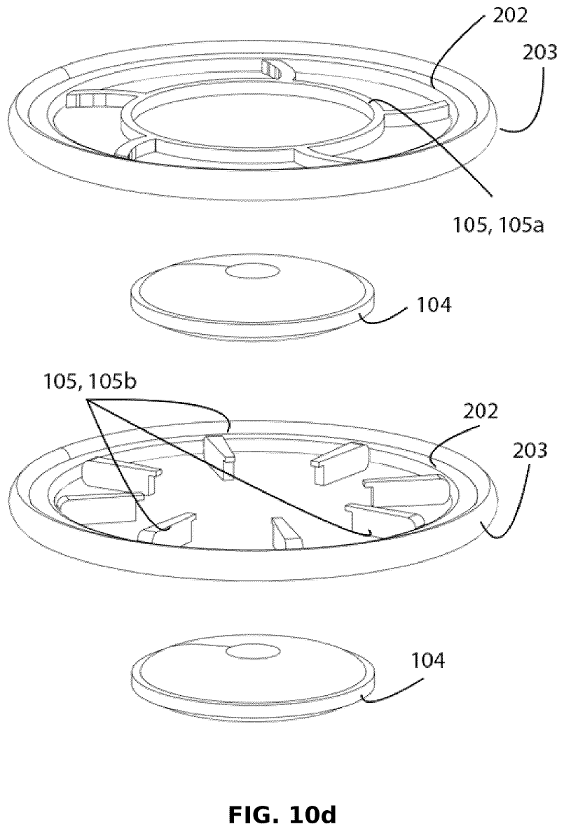

In another embodiment, as generally depicted in FIG. 10c, the first ring 104 is secured to an outer surface of the rotor having an inner ring of magnets 101 with the first ring 104 having a track or series of tracks milled or otherwise fabricated into its structure which permits the corresponding structure 105 or structures to be pressed into place and then be rotated into a final locking position, at which point an integral spring-loaded catch or catches or other generally known machine element on the corresponding structure or structures fall or spring or move into place and prevent backing out, much like how a camera lens may be affixed to a body of a camera. In alternate embodiments of a similar mechanism, spring loaded clamps, pins, captive rotating wedges, ratchet and pawl mechanisms, or other affixing devices that may be housed in the first ring 104 or in the corresponding structure 105 or structures may prevent the backing out from this track and keep the corresponding structure or structures 105, such as a corresponding structure 105a of the at least a second ring 105 firmly in place.

In another embodiment, the first ring 104 may be threaded with a coarse thread that allows the corresponding structure 105 or structures to screw into firm fitment, at which point spring loaded clamps, pins, captive rotating wedges, ratchet and pawl mechanisms, or other affixing devices that may be housed in the first ring 104 or in the corresponding structure or structures prevent the screw connection from backing out.

In another embodiment, the first ring 104 may include a plurality of locking tabs 142 which, upon assembly, couple the first ring 104 to the second ring 105, wherein the locking tabs 142 are twisted in order to couple with a corresponding groove on the at least second ring 105 to lock the first ring 104 and second ring 105 together axially along the first diameter 140 and the second first diameter 150, as is shown in FIG. 10.

In another embodiment, shown in FIG. 10a, the first ring 104 has a groove and a series of through-holes that enable coupling with the at least second ring 105, which has corresponding fixed bolts that allow the rings 104, 105 to be statically coupled in terms of relative rotation; further, some number of these bolts may have a male thread onto which corresponding locking tabs with captive female-threaded bolts attach, clamping the at least second ring 105 to the first ring 104 in place in terms of axial translation.

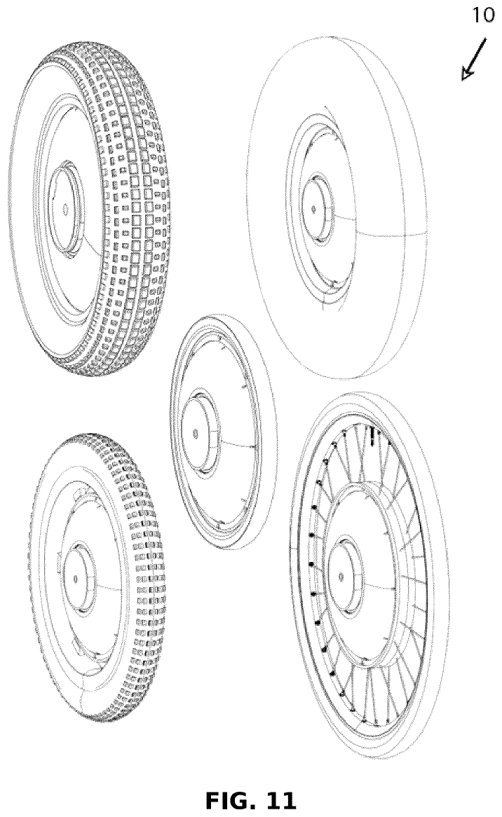

Accordingly, the device 10 wheel assembly 200 coupled to the second ring 105 or corresponding structure 105a or structures and the rim 202 may include a tire 203 that can be provided in a multitude of types and styles (shown in FIG. 11) based upon the surface or environment the device 10 is operated upon or other operational conditions. Additionally, the coupling of the first ring 104 and the at least second ring 105 or corresponding structure or structures allows for the attachment of alternative rotatable couplings such as rim/tire assemblies, a gear configured for powering an additional gear, a rim for driving a belt, a coupling for driving a shaft, turbine blades for the generation of wind power, propeller blades for use underwater, and other rotatable couplings.

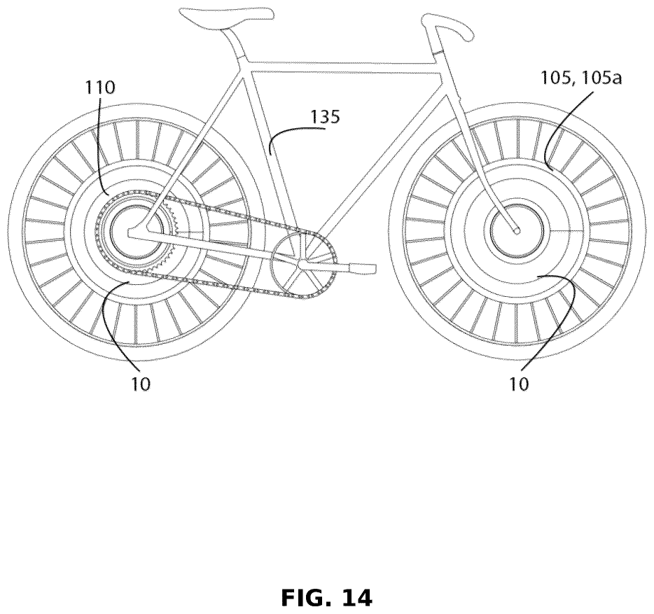

In one embodiment, a total axial width of the device 10 is less than a distance of the space between the front or rear dropouts of a common bicycle with the device 10 having a central keyed, splined or circular aperture through which a connecting rod may be inserted in order to fix the device 10 in place and provide for the coupling of the device 10 stator 102 to a bicycle frame at least one attachment 135 for use in converting a conventional bicycle to an electric bicycle as is depicted in FIG. 14. In another embodiment, a special fork may be used which replaces a traditional bicycle fork and has mounting structures intended to mount to the generally hollow axle 103 attachment structure 131 or interface device 134.

The primary defining characteristics of the device 10 design may be adapted to a smaller or larger form factor, and the ratio of radius to axial length may be altered to accommodate different classes of application which are sufficiently different as to limit the quality of compromise reached by a single embodiment of device 10. Two such embodiments are shown in FIG. 9B.

The motor 100, hollow axle 103, and wheel 200 assembly allows for modular and universal use for a variety of transportation and other needs. Further, the device 10 of the present disclosure includes a multitude of electronic components including but not limited to, additional controllers, gyroscopes, accelerometers, and sensors adapted to provide for operation and movement of the features and systems.

The device 10 interface device 134 attachment structures 131 provide a means to mount riding platforms and parent vehicle or machine structures simultaneously or separately, such as an enclosing case in combination with pedals, or a mudguard in combination with a riding platform.

In other embodiments, the device 10 rotor 101 may have features that enable the semi-permanent or quick attachment of a chain or belt sprocket or other similar feature on one or both opposed sides of the device 10. This attachment system in general will consist of a mounting surface that does not penetrate the shell of the rotor, and may consist of a raised tapped face, or a thickened section with blind tapped holes, or other features which enable a quick attachment of a sprocket or similar output drive device that do not compromise the integrity of the rotor shell. This attachment sprocket will have a smaller diameter to which it mounts than the first ring 104, providing an easy means by which the torque of the motor drive may be increased, and the RPM range of the motor drive may be decreased, and facilitates additional uses of the device 10 beyond those possible with attachments about the first ring 104. In one embodiment, this attached sprocket may be used to allow the device 10 to functionally replace the rear wheel of a bicycle and accept the drive chain from the pedal driven crank. In another embodiment, this sprocket system may be used to gain additional torque or mechanical advantage in the case that the device 10 is used to reel in wire or rope, or otherwise drive a smaller wheel requiring higher torque and lower speed.

In other embodiments, the device 10 rotor 101, may be fixed in a frame, functionally allowing the stator 102 to rotate about the rotor 101 internally within the device 10. In general, this may not be a preferred usage because it imposes circumferential force on the batteries 300, controller 109 and other internal systems and may be limited in RPM due to rotational imbalance caused by uneven weight distribution of the working components fastened to the stator such as the motor controller, but in general may increase the usefulness of the device 10, and in general because of the effective reduction in output drive circumference, will result in a lower RPM and higher torque. In particular, in many applications, this may be useful for driving a smaller wheel, sprocket, drum or other device on one or both sides of the device 10 at lower speed and with higher torque, such as in winching or hoisting operations, or crawling a wheel, or other such uses for high torque low speed motors.

The device 10 may include electronic systems which enable the controller 109 and control system of the device 10 to automatically determine the type of modular components in use, in order to enable user-friendliness. In the case that the device 10 is in use as part of a bicycle, the device 10 should know certain parameters like the diameter and nature of the wheel attachment in use, and the type or types of control peripherals in use such as throttles, torque sensors, environmental sensors, among other parameters relevant to the control system. In the case that the device 10 is in use as a self-balancing vehicle intended to be ridden facing in the direction of travel, the device 10 control algorithm may benefit from including information about the shape and nature of the riding platforms arm and a diameter of the wheel attached, among other parameters relevant to the control system. Accordingly, device 10, along with the modular attachments, may include active or passive wired or wireless features, such as radio-frequency identification (RFID) or Bluetooth which communicate universally unique identifiers (UUIDs) registered in a memory of the controller 109 or other information, to enable the control system of the controller 109 to receive the identity of an attached component in order to automatically adjust a control algorithm to suit the connected attachments 135. For example, this automatic adjustment may take the form of applying control loop parameter tables tuned for specific wheel types and diameters or altering the control loop in use in order to alter the behavior of the device 10 to match an attachment 135, such as, but not limited to, an attached riding platform or parent vehicle or machine structure which may imply a different set of operational conditions or intended uses.

The device 10 may include wired or wireless interface systems which enable the continuous transfer of information to and from the device 10. In one embodiment of this feature, device 10 may use a wired or wireless connection to a control peripheral such as, but not limited to, a throttle which a user utilizes to control the speed, responsiveness, or other parameters of the device 10 control system while in use.

The device 10 may include wired or wireless interface systems which enable the continuous transfer of information to and from the device 10 with other units of the device 10 or a master control unit, to enable the coordination of the individual device 10 with one another, such as in the case of a multi-wheel vehicle such as, but not limited to, a motorcycle, tricycle, car or other vehicle or machine type including multiple powered wheels.

The device 10 may include radio receivers, transmitters, and antennas such as, but not limited to, cell network modules, or geolocation modules, coupled to the controller 109 to enable device 10 to communicate and or receive information via these networks.

The device 10 generally hollow axle 103 may include on one side an electrical coupling interface structure such as a fixed plate having a plurality of features and contact points to mount power, control and information interfaces with the device 10, such as a power button, status indicators, wire plug receptacles for power and/or information exchange, or other buttons that enable operation of the device 10.

The device 10 may include a plurality of features to enable power management to permit the usage of multiple energy sources at once, and to selectively deliver power to external attachments or systems. In one embodiment, this power may be sent to a circuit containing a large resistor or array of resistors, or other energy dissipating devices, to increase the controller's 109 ability to dissipate power, in the event that the device 10 is required to slow down using regenerative braking or convert its momentum into electrical or chemical energy more rapidly than the charge rate of its battery permits. In another embodiment, this selective power distribution may be delivered to servos, actuators, or other motors that may be mounted to a frame or structure attached to the device 10 to enable dynamic behavior in addition to the controller's 109 ability to rotate the rotor 101 about the stator 102, such as actuation of movable arms, guards, stands, platforms, or active suspension systems. This power management system may provide a series of different voltages, ranging from low energy sources intended to power peripheral devices like speakers or lights to full system power intended for actuation of additional motors, servos, and actuators.

The device 10 may have structures or devices which permit a main operating power to be available to powered rotating attachments mounted on the rotor 101. In one embodiment, an electrical circuit may be enabled by the use of an electrical slip ring type device mounted to the rotor 101, with corresponding spring-loaded brushes connected to the stator 102, and wires leading up the rotor 101 to the first ring 104. In another embodiment, this circuit may be enabled by the isolation of one side of the rotor 101 from an opposed other side of the rotor 101, and generally one side of the axle 103 from the other, which permits the creation of an electrical potential between two rotor shells. This electrical circuit may be used to deliver power to rotatable attachments coupled to the first ring 104, which would enable the attachment of dynamically powered adjustable wheels which use actuators to alter the position of their constituent parts, shape, state of inflation, protrusion, or retraction of tread features such as studs, or other dynamic features intended to enhance rideability or use. In both embodiments, the electrical power transmission circuit may be paired with a communication circuit to enable wired control of powered rotating attachments.

In embodiments, the device 10 may include a fixed or removable battery located within the axial and radial extents of the device 10, such as a battery mounted to the stator 102 supporting structure, or axially asymmetrically mounted to the axle 103, located in a concavity of the rotor 101, external to the rotor 101, which is intended to be used as the primary energy source of the device 10 in exclusion or augmentation of a removable battery energy source 300 for the purpose of powering the motor 100.

The device 10 may include an attachment, intended to be attached to the axial attachment structures 131, which includes an additional and/or larger battery intended to increase the available power and energy capacity of the device 10 beyond that possible with a removable battery 301 housed within the limited space of the generally hollow axle 103. In one embodiment, this attachment is a case for a self-balancing vehicle intended to be ridden facing forward which contains a battery which may be coupled to the controller 109 via the generally hollow axle 103. In another embodiment, this attachment is a bicycle frame which has a large battery mounted to it which may be coupled to the controller 109 via the generally hollow axle 103.

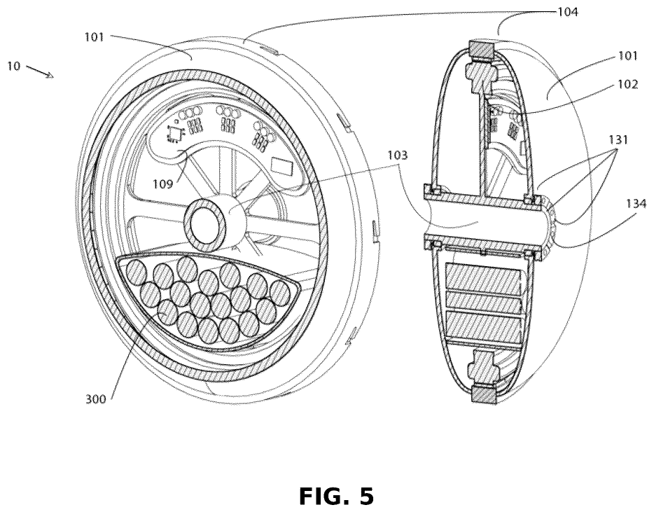

In an embodiment, the device 10 may include an internal battery which is not readily removable during the course of use, mounted to the stator supporting structure, as generally depicted in FIG. 5. In this embodiment, the device 10 preferentially retains all features and systems which enable energy exchange with external machines and energy sources, as well as the quick-attachment structures and systems generally discussed herein but does not provide a removable battery.

The device 10 may in embodiments include an auxiliary internal battery used to provide power to information or location systems inside the device 10 which allow for their continual operation regardless of the state of charge or presence of the replaceable battery 301 or energy source 300.

The device 10 energy source 300 may include an internal battery management system to enable the safe use and operation of the system while in use as well as when the energy source 300 is removed from the device 10 and charged externally.

The device 10 energy source 300 may include a control system with memory that maintains logs of charge and use behavior over time, prevents unauthorized use, tracks the location of the unit through geolocation systems, or other uses. Such data logging and control may facilitate public battery sharing programs and battery problem diagnosis.

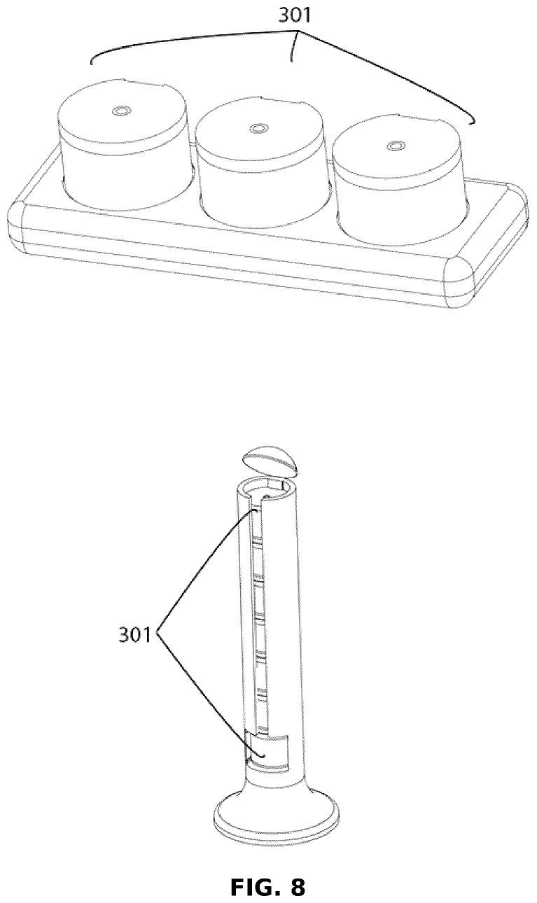

The device 10 energy source 300 may be charged by home charging units, or be charged by specially designed bulk, or public charging units, as in FIG. 8. One of the limiting factors in any electric mobility machine in use is the amount of energy that can be stored in a device at one time, and that such energy storage units are generally not of a universal or modular type. When the energy stored in an electric vehicle runs out, unless the battery can be replaced, the user must find a charging station and wait (typically up to an hour) until the vehicle is recharged. Public charging units such as those depicted in FIG. 8, below, may further enable and catalyze public use of electric mobility solutions where networks of charging devices can be set up.

One of the liabilities of ownership of an electric device is the cost and limited lifetime of the battery in use. Batteries sometimes fail early due to failure of a few of their underlying components, when otherwise the system may have had significant remaining usable life. Systems of public charging units such as in FIG. 8 which utilize modular energy sources such as 301, may enable a group of people to share the cost of owning and maintaining electric mobility vehicles by a subscription or shared ownership system.

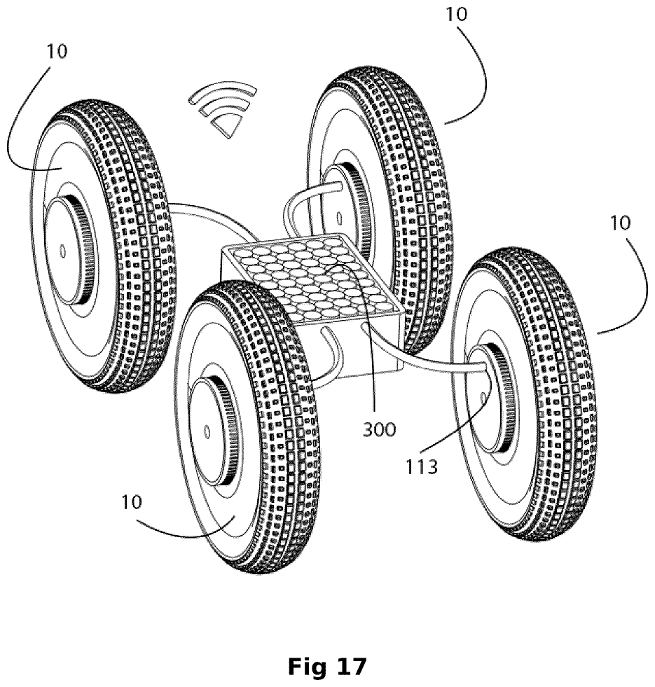

The device 10 hollow axle 103 may include a plurality of features and contact points to enable energy exchange with external systems and structures. In one embodiment, the device 10 may utilize external energy sources instead of or additional to the removable battery assembly 301. In such case, an assembly of multiple units of the device 10 may be created that utilize the same energy source, as depicted in FIG. 17. In one embodiment, the device 10 hollow axle 103 may receive a plug which contains power transmission wires and/or digital or analog signal wires that facilitate power receipt, transmission, and communication with other units of the device 10, external battery packs, or other systems or devices.

The device 10 may include a plurality of wired or wireless features to enable communication between multiple units of the device 10, and/or with control peripherals, external sensors, systems, or mobile devices such as cell phones. In one embodiment, this information interchange capability allows for multiple units of the device 10 to be combined together into a single vehicle, and communicate in a mesh, or master/slave structure to enable the coordinated work of each device 10 in the operation of the constructed vehicle. This communication may enable a single throttle to power all units of device 10, for the devices 10 to share information about wheel traction and update their behavior accordingly to improve traction, or otherwise augment their behavior to enable desirable features of the constructed vehicle.

The device 10 may be used as a power generation device. In this embodiment, the device 10 may be put in an electrical coupling via an electrical interface within the central hollow core 103 to an external power storage device. In this embodiment, the device 10 may be coupled to a housing or frame by means of the attachment structure 131, and receive an attachment on the rotor 101 such as, but not limited to, a belt or gear drive coupled to a mechanical power source, windmill blades for use in generating wind power, or water wheel blades for use in generating water-based power.

The device 10 may be configured for use as a battery-operated power tool by attachment of rotatable couplings such as, but not limited to, grinding, or cutting blades, fan blades, or a belt-drive system intended to power a machine.

The device 10 may be configured in a waterproof housing and may be submersible and/or usable in a marine environment as a motor, as a direct drive propeller, or in a gear, belt, or similar coupling to a propeller shaft for powering a marine vehicle or machine.

The device 10 may be configured for use in exercise equipment, by providing programmable intelligent resistance against rotating forces imparted by the user via an attachment or system of attachments, such as in a rowing machine, elliptical machine, a machine incorporating rope or strapping which is pulled by a user in order to strengthen various muscles, and other machines of this type.

The device 10 may be configured for use in utility devices such as powered wheelbarrows, powered utility carts, powered lawn and garden devices such as lawn mowers or rototillers, or other machines of this type.

The device 10 may be configured for use in conveyor belt systems, powered portable pulley and winch systems, cable reels and ascenders or traversers, or other machines of this type.

The device 10 may be configured for use as a rotating power source for powering tools such as belt sanders, rotating grinding tools, powered fans, grinding wheels, band saws, circular saws, water or other liquid pumps, or other tools of this type.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A powered device configured to rotate an object, such as a wheel, about a central axis of rotation, the device comprising:
a brushless motor of the direct current (DC) type having a circular stator with a central cavity and a circular rotor configured for rotational movement about the circular stator;
a controller, the controller coupled to the circular stator and generally configured to direct operation of the device and movement of the circular rotor in a clockwise or counterclockwise direction;
a generally hollow axle located within the central cavity in a fixed coupling with the circular stator and having an interior space, and having a pair of attachment structures, with each attachment structure of the pair of attachment structures on an opposed side of the circular stator;
an at least one energy source, the at least one energy source coupled to the controller for powering operation of the brushless motor;
a first ring having a first diameter, the first ring semi-permanently coupled to the circular rotor, wherein the first ring is secured to the circular rotor and will rotate about the generally hollow axle when directed;
a corresponding structure that may be removably affixed to the first ring, wherein the corresponding structure generally translates the rotation of the circular rotor for use; and
an at least one attachment configured for receipt in a coupling with at least one of the attachment structures of the pair of attachment structures.

2. The powered device as in claim 1, wherein the at least one energy source is received within the interior space of the generally hollow axle.

3. The powered device as in claim 2, wherein the at least one energy source is a removable battery.

4. The powered device as in claim 1, wherein the at least one energy source is mounted to the circular stator within an interior space of the circular rotor.

5. The powered device as in claim 1, wherein the at least one energy source is mounted to the generally hollow axle and positioned outside of an interior space of the circular rotor.

6. The powered device as in claim 5, wherein the at least one energy source is a removable battery.

7. The powered device as in claim 1, wherein the at least one energy source is mounted to the at least one attachment.

8. The powered device as in claim 1, wherein the brushless motor of the direct current (DC) type is of the radial flux type.

9. The powered device as in claim 1, wherein the brushless motor of the direct current (DC) type is of the axial flux type.

10. The powered device as in claim 1, wherein the controller is configured for a communicative coupling with the at least one attachment when received in the coupling with at least one of the attachment structures of the pair of attachment structures.

11. The powered device as in claim 1, wherein the at least one attachment includes multiple attachments, with each attachment of the multiple attachments received on the same attachment structure of the pair of attachment structures.

12. The powered device as in claim 1, wherein the at least one attachment is attached to each attachment structure of the pair of attachment structures on opposed sides of the stator.

13. The powered device as in claim 1, wherein the corresponding structure is a second ring with the second ring having a second first diameter corresponding to the first diameter of the first ring, the second ring configured for a removable intermeshed coupling with the first ring, wherein rotation of the first ring is translated to rotation of the second ring.

14. The powered device as in claim 1, wherein the corresponding structure is a ring of structures arranged around a second first diameter corresponding to the first diameter of the first ring, with the ring of structures configured for a removable intermeshed coupling with the first ring, wherein rotation of the first ring is translated to rotation of the ring of structures, and wherein the ring of structures may be easily removed as one unitary body.

15. The powered device as in claim 1, wherein the corresponding structure is in a semi-permanent assembly with a rim and a tire.

16. The powered device as in claim 1, wherein the brushless motor circular rotor is two circular rotor shells which support an electromagnetically active portion of the at least one circular rotor and permit the two circular rotor shells to rotate about the generally hollow axle, with each circular rotor shell of the two circular rotor shells located on an opposed side of the circular stator.

17. The powered device as in claim 16, wherein the circular rotor has features to enable the mounting of an alternate output drive to a side of the circular rotor.

18. The powered device as in claim 16, wherein the controller is configured to provide power and information exchange with the rotatable attachments mounted on the first ring.

19. A powered device configured to rotate an object, such as a wheel, about a central axis of rotation, the device comprising:
a brushless motor of the direct current (DC) type having a circular stator with a central cavity and a circular rotor configured for rotational movement about the circular stator, the rotor being comprised of two rotor shells which support an electromagnetically active portion of the rotor so that it may rotate about a generally hollow axle;
a controller, the controller coupled to the circular stator and generally configured to direct operation of the device and movement of the rotor in a clockwise or counterclockwise direction;
the generally hollow axle located within the central cavity in a fixed coupling with the circular stator and having an interior space, and a pair of attachment structures, with each attachment structure of the pair of attachment structures on an opposed side of the circular stator, and
providing an internal electrical coupling for the attachment of energy sources, and providing an electrical coupling interface structure at one end for mounting power, control, and information exchange interfaces, and configured for receipt of a removable energy source;
an at least one energy source, the at least one energy source coupled to the controller for powering operation of the brushless motor, and configured so as to be removably coupled into the interior space of the generally hollow axle;
a first ring having a first diameter, the first ring coupled to the circular rotor, wherein the first ring is secured to the circular rotor and will rotate about the generally hollow axle when directed;
an at least one second ring corresponding structure that may be removably affixed to the first ring, wherein the second ring generally translates the rotation of the circular rotor for use;
an interface device semi-permanently coupled to the generally hollow axle which provides an attachment structure by which attachments may be removably coupled to the stator; and
an at least one attachment configured for receipt in a coupling with at least one of the attachment structures of the pair of attachment structures.

20. The powered device as in claim 19, wherein the at least one energy source is mounted to the at least one attachment.

21. The powered device as in claim 19, wherein the brushless motor of the direct current (DC) type is of the radial flux type.

22. The powered device as in claim 19, wherein the brushless motor of the direct current (DC) type is of the axial flux type.

23. The powered device as in claim 19, wherein the controller is configured for a communicative coupling with the at least one attachment when received in the coupling with at least one of the attachment structures of the pair of attachment structures.

24. The powered device as in claim 19, wherein the at least one attachment includes multiple attachments, with each attachment of the multiple attachments received on the same attachment structure of the pair of attachment structures.

25. The powered device as in claim 19, wherein the at least one attachment is attached to each attachment structure of the pair of attachment structures on opposed sides of the stator.

26. The powered device as in claim 19, wherein the corresponding structure is in a semi-permanent assembly with a rim and a tire.

27. The powered device as in claim 19, wherein the controller is configured to provide power and information exchange with the corresponding structure rotatable attachments mounted on the first ring.

28. The powered device as in claim 19, wherein the circular rotor has a structure to enable the mounting of an alternate output drive to the circular rotor shell on an axial side of the circular stator.
